(19) United States
(12) Patent Application Publication
(10) Pub. No.: US 2010/0171373 A1
(43) Pub. Date: Jul. 8, 2010

(54) AIRCRAFT SERVICE PIT WITH A GROUND POWER UNIT

(75) Inventors: Soren Risgaard Dahl, Odense (DK); Bo Vork Nielsen, Morud (DK); Henrik Olsson, Odense (DK)

Correspondence Address: FLETCHER YODER (ILLINOIS TOOL WORKS INC.), P.O. BOX 692289, HOUSTON, TX, 77269-2289, US

(73) Assignee: Illinois Tool Works, Inc., Glenview (IL)

(21) Appl. No.: 12/601,272

(22) PCT Filed: May 12, 2008
(86) PCT No.: PCT/IB08/01165

§ 371 Date: Nov. 22, 2009

(30) Foreign Application Priority Data
May 25, 2007 (DK) PA 2007 00767

(51) Int. Cl. H02J 4/00

(52) U.S. Cl. 307/154

(57) ABSTRACT

The present invention relates to an aircraft service pit accommodating a GPU for supply of electrical power to an aircraft on the ground. More specifically it relates to a pit with a GPU comprising a housing enclosing a frequency converter for provision of a stabilized multi-phase alternating output voltage to an aircraft through an output cable.

### CROSS REFERENCE TO RELATED APPLICATIONS

This application claims priority from and the benefit of PCT Application No. PCT/IB2008/001165, filed on May 12, 2008; and Denmark Patent No. PA 2007 00767, filed on May 25, 2007; entitled “An Aircraft Service Pit with a Ground Power Unit”, which is herein incorporated by reference.

### BACKGROUND

The present invention relates to an aircraft service pit accommodating a ground power unit (GPU) for supply of electrical power to an aircraft on the ground.

At many airports and airfields throughout the world, aircraft ground support electricity, air conditioning, fuel, and other aircraft servicing necessities are provided from pits located beneath the surface across which the aircraft travel while on the ground. These pits provide subsurface terminations for aircraft servicing facilities such as fuel lines, electrical power supply lines, air conditioning ducts, and other auxiliary services which are provided to an aircraft that are on the ground.

The use of subsurface pits serves to reduce the congestion of motorized vehicles and lines running across the aircraft servicing areas that would otherwise exist.

Aircraft servicing pits typically take the form of hollow, fibreglass enclosures that are buried in excavated holes dug beneath aircraft servicing areas. Fuel lines, electrical lines, air conditioning lines and other ground support auxiliary service lines are typically laid down during the construction of the airport or aircraft terminal in trenches that are ultimately filled in. These lines run from the terminal facility to the aircraft servicing pits and are accessible through aircraft servicing pit lid assemblies that are located at the top of the pits.

Typically, GPUs are located in a terminal facility of the airport and the aircraft supply voltage is fed to the aircrafts through relatively long power cables extending from the GPUs to the respective aircraft servicing pits. GPUs of this type are well known. Typically, the units are driven by a 50 Hz or 60 Hz 3-phase input voltage and generates a desired 3-phase 400 Hz alternating output voltage or a 28 V_{DC} voltage. The long power cables may lead to decreased output voltage quality at the output of the power cable.

Typically, an AC power cable has at least one conductor for each phase of the converter output voltage and at least one neutral conductor. Further, the power cable has a number of wires for control signals. For example, push buttons are available at the pit allowing the operator to turn the power supply for the aircraft on and off. Further, a wire for the interlock control signal may be provided. The interlock signal, typically a 28 V_{DC} signal, is forwarded from the aircraft to the GPU and indicates that the aircraft receives the required voltage quality. If the GPU does not receive the interlock signal, the GPU is turned off.

Thus, long, complex and costly cables of high quality that can withstand the harsh environment of an airport are required for supplying the aircraft on the ground from a pit.

### BRIEF DESCRIPTION

There is a need for an improved pit system in which simpler cables may be used for long distances thereby lowering the cost and increasing the reliability and quality of such systems.

According to the present invention, the above-mentioned and other objects are fulfilled by an aircraft service pit containing a GPU with an input for a mains voltage of a mains frequency supplied to the pit and a stabilized output voltage connected with an output cable for supplying the output voltage to an aircraft parked proximate the pit.

Accommodation of the GPU within the pit further reduces the congestion of motorized vehicles, equipment, and lines running across the aircraft servicing areas.

Further, bringing the GPU close to the parked aircraft minimizes the length of the power cable between the aircraft and the GPU, whereby a high quality of the output power supplied to the parked aircraft is maintained.

It is a further important advantage of the present invention that power cables extending between the airport terminal and the parked airplane are simplified leading to lowered cost.

The mains supply available at airports is typically the mains supply generally available in the country of the airport, e.g. in Europe: 50 Hz, 400/230 Vᵣₘₛ and 60 Hz, 460 Vᵣₘₛ in USA. The output voltage is typically a 3-phase 400 Hz, 200/115 Vᵣₘₛ output voltage or a 28 V_{DC} voltage as for example supplied by GPUs similar to the well-known AXA 2200 series of solid state ground power units.

### DRAWINGS

Below the invention will be described in more detail with reference to the exemplary embodiments illustrated in the drawing, wherein:

FIG. 1 shows an aircraft parked proximate an aircraft service pit according to the present invention,

FIG. 2 shows a cross-section of an aircraft service pit according to the present invention,

FIG. 3 is a simplified block diagram illustrating a voltage drop compensation control circuit,

FIG. 4 shows a blocked schematic of the output circuit topology of one embodiment of the frequency converter, and

FIG. 5 shows a blocked schematic of the output circuit topology of another embodiment of the frequency converter.

### DETAILED DESCRIPTION

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

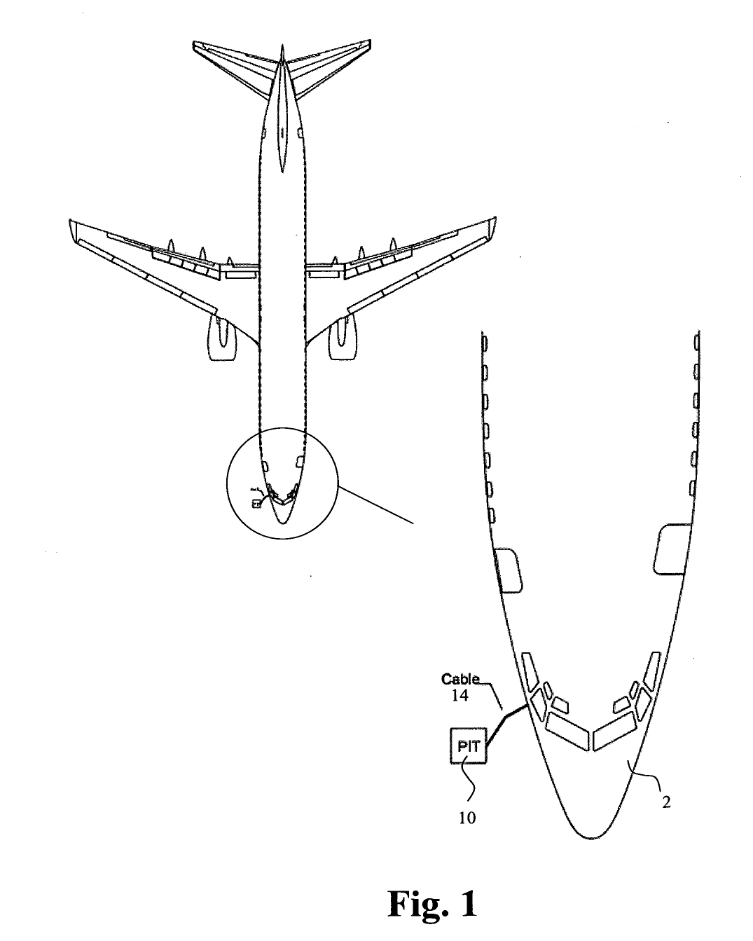

FIG. 1 shows an aircraft 2 parked proximate an aircraft service pit 10 according to the present invention. It is noted that the area occupied by interconnections between the aircraft 2 and the pit 10 is kept at a minimum thereby leaving most of the apron area available for other tasks. It should also be noted that the power cable between the aircraft and the GPU is very short, whereby a high quality of the output power supplied to the parked aircraft is maintained.

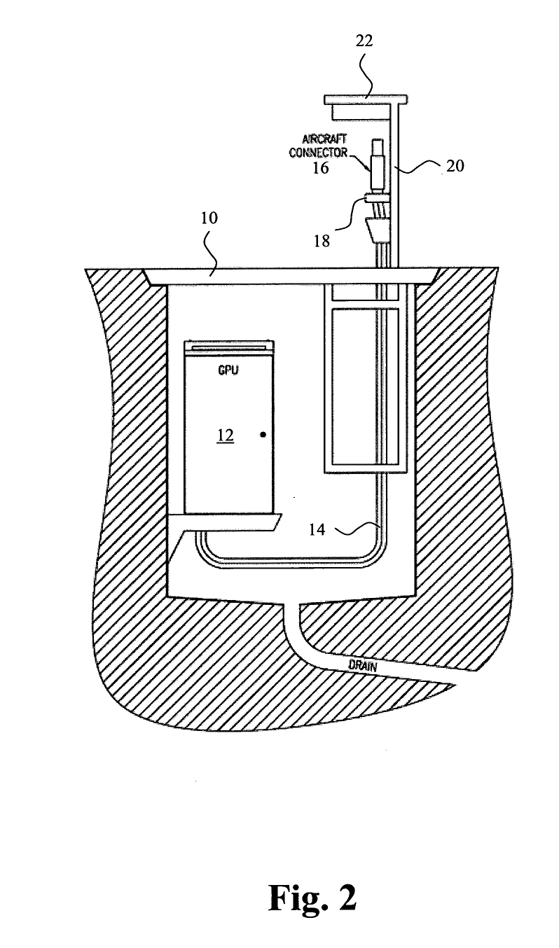

FIG. 2 shows a typical mounting position of a GPU 12 in an aircraft service pit 10 according to the present invention. The GPU mounted in the illustrated position fulfils the ATEX directive for equipment intended for use in potentially explosive atmospheres. In another embodiment of the pit, the GPU is mounted in a columnar frame that can be displaced vertically so that the GPU can be raised and positioned outside the pit above the ground during operation thereby lowering the ATEX requirement for the GPU. When the GPU is not used, the GPU can be lowered into the pit.

Reverting to FIG. 2, the output cable 14 is shown stowed within the pit 10 with its connector 16 in a reachable position in a holder 18 in a columnar frame 20 that can be displaced up and down. In its lowest position, the pit 10 is closed with the cover 22 of the columnar frame 20 so that an airplane or another vehicle may drive across the closed pit 10. The connector 16 may have push buttons, for example for power-on and power-off. Alternatively or additionally, push buttons may be situated at the columnar frame 20.

When the GPU 12 is not in use, the output cable 14 is stowed in the pit 10 and the columnar frame 20 is lowered to its pit 10 closing position. In order to connect an aircraft 2 to the GPU 12, the columnar frame 20 is raised so that the power cable connector 16 can be removed from the holder 18 and a desired length of the cable 14 can be withdrawn from the pit 10 controlled by the operator. Finally, the cable connector 16 is inserted in a corresponding receptacle in the aircraft 2 to receive power supply from the GPU 12.

As already mentioned, the mains supply available at airports is typically the mains supply generally available in the country of the airport, e.g. in Europe: 50 Hz, 400/230 Vᵣₘₛ and 60 Hz, 460 Vᵣₘₛ in USA. The output voltage supplied by the GPU is typically a 3-phase 400 Hz, 200/115 Vᵣₘₛ output voltage and/or a 28 V_{DC} voltage as for example supplied by GPUs similar to the well-known AXA 2200 series of solid state ground power units.

The following description relates to a GPU supplying a 3-phase 400 Hz, 200/115 Vᵣₘₛ output voltage, however the person skilled in the art will recognize that the illustrated unit may readily be substituted by another GPU supplying another output voltage, such as a DC-voltage, a single phase AC voltage, a 3-phase voltage, etc., or any combination of AC and DC output voltages.

The illustrated GPU 12 weighs around 350 kg and its dimensions are app. 0.6 m*1.1 m*0.6 m (H*L*W). The cable 14 has a diameter of app. 4 cm and contains in addition to cable conductors for the 400 Hz 3-phase AC power supply a number of conductors for control signals, e.g. interlock and communicating signals from possible push buttons to the controller of the GPU 12.

The illustrated GPU 12 has a housing with an input for a mains voltage of a mains frequency, e.g. 50 Hz, 400/230 Vᵣₘₛ, or, 60 Hz, 460 Vᵣₘₛ, and enclosing a frequency converter for generation of a stabilized multi-phase alternating output voltage, in the illustrated embodiment a 3-phase 400 Hz/115Vᵣₘₛ output voltage. The converter is connected with an output cable 14 for supplying the output voltage to a load (not shown). The frequency converter of the illustrated embodiment comprises a rectifier connected to the mains voltage for provision of a rectified DC voltage to the input of an inverter including a transformer-filter part that generates the desired output voltage.

The GPU 12 further comprises a controller that is adapted to control the frequency converter.

As already mentioned, the cable connector 16 of the illustrated embodiment contains push buttons for activation by the GPU user. In other embodiments of the pit 10, such push buttons may be provided at the pit 10, for example at the columnar frame 20. The push buttons are connected to the controller of the GPU 12 through control conductors contained in the cable 14. One push button is pressed to apply the output voltage to the aircraft 2 upon connection with the aircraft 2 and a push button is pressed to turn the output voltage off before disconnecting the connector 16 from the aircraft 2. The GPU controller controls the functioning of the push buttons.

The GPU controller may also be adapted for control of various parameters of the GPU 12 in accordance with the current operating conditions, such as the actual load, abrupt load changes, etc., e.g. for provision of a high quality output voltage.

Parameters controlled by the controller may include at least one of the following: individual phase angle of the output voltage, individual phase voltage amplitude, frequency, etc.

The controller may be connected to an operator interface with push buttons, lamps and displays for inputting operator commands to the unit and for displaying various states of the GPU 12 to the operator.

For GPU management, the controller has at least one control output for control of the frequency converter, such as switch frequency. Further, the controller may be capable of controlling the phase angle of the output, and of individually controlling each of the output voltages of the output phases.

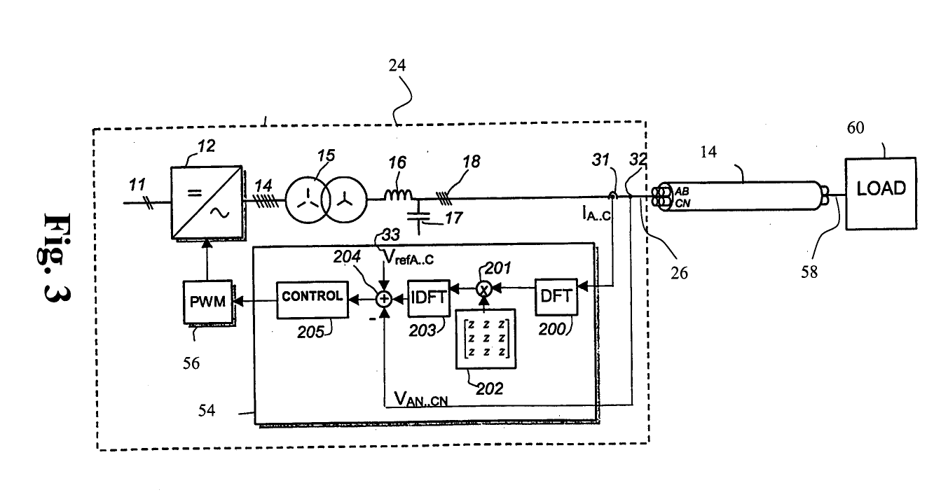

FIG. 3 schematically illustrates a voltage drop compensation control circuit of an exemplary frequency converter 24 in more detail. In the illustrated example, the controller 46 includes control circuitry 54, 56 at the frequency converter 24 adapted for compensation of the impedance of the output cable 14 for provision of a supply voltage 58 of improved quality at the connection to the load 60. In this way, the voltage drop of the cable 14 may be compensated by controlled and appropriate increase of the output voltage 26 of the frequency converter 24. Likewise the phase of the output voltage 26 of the frequency converter 24 may be controlled to compensate for phase changes in the output cable 14. A method of compensating voltage drop in a multi-conductor cable is disclosed in EP 1 278 284. Present FIG. 5 corresponds to FIG. 1 of EP 1 278 284. Reference is made to the corresponding part of the description of EP 1 278 284. In the disclosed method, the impedance matrix of the cable 14 is determined by short circuiting the cable conductor at the remote end of the cable 14. The determined matrix 202 is stored in control circuitry 54.

The compensation for output cable impedance makes it possible to utilize low cost asymmetric multi-conductor cables and still provide a supply voltage 58 at the load 60 of the desired quality.

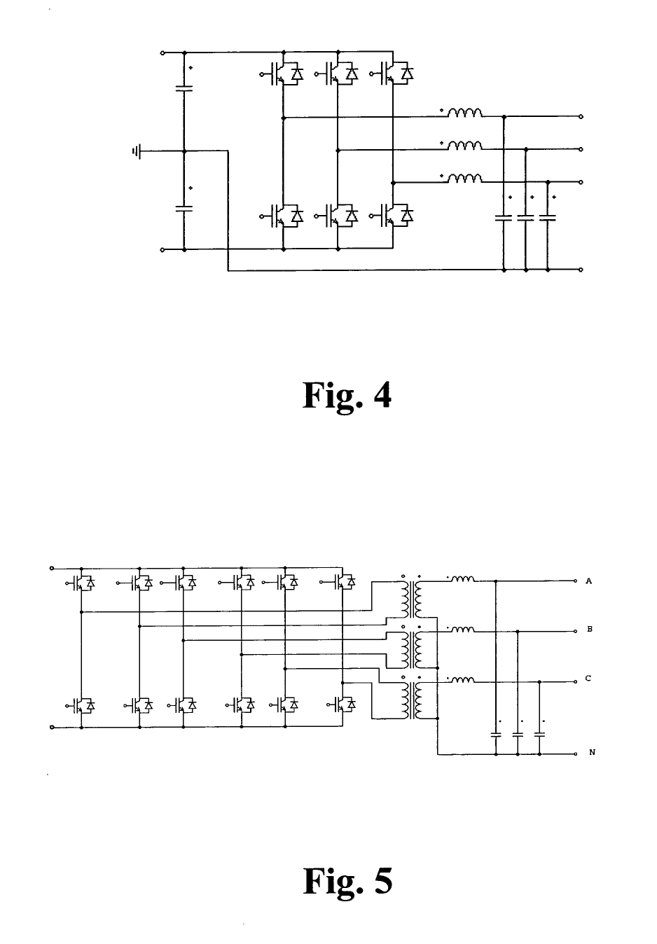

FIGS. 4 and 5 schematically illustrate two circuit topologies of the frequency converter 24. The circuit topology is selected so that the individual phase outputs of the frequency converter are controllable independent of the other phase outputs. Thus, the most common inverter topologies with star coupled or triangular coupled 3-phase transformers cannot be used, because of the absence of a physical neutral. In such couplings an asymmetric load will cause the three phases of the output voltage to become correspondingly asymmetric. In the embodiment shown in FIG. 4, a centre tap is provided from the DC voltage generated by the rectifier 40, and the switches generating the 400 Hz alternating output voltage are arranged for individual control of the output voltage of each of the output phases by proper pulse width modulation of the switches as is well known in the art. In an alternative topology shown in FIG. 5, twelve switches are arranged in three H-bridges connected to the DC voltage without a centre tap for provision of individually controllable output phase voltages. As shown in FIG. 5, the H-bridge topology requires a transformer.

1. An aircraft service pit containing a ground power unit with an input for a mains voltage of a mains frequency supplied to the pit and a stabilized output voltage connected with an output cable for supplying the output voltage to an aircraft parked proximate the pit.

2. An aircraft service pit according to claim 1, wherein the stabilized output voltage is a stabilized multi-phase alternating output voltage.

3. An aircraft service pit according to claim 1, wherein the stabilized output voltage is a stabilized direct current output voltage.

4. An aircraft service pit according to claim 1, wherein the ground power unit is mounted in a columnar frame that can be displaced vertically so that the ground power unit can be raised and positioned outside the pit above the ground during operation.

5. An aircraft service pit according to claim 1, further comprising a user interface for generation of control signals to a controller of the ground power unit in response to respective user inputs.

6. An aircraft service pit according to claim 5, wherein the controller is further adapted for individual phase regulation of each of phase of the output voltage.

7. An aircraft service pit according to claim 5, wherein the controller is further adapted for active suppression of harmonic distortion of the output voltage.

8. An aircraft service pit according to claim 5, wherein the controller is further adapted for controlling a phase of a frequency converter output for no-break power transfer connection to the load.

9. An aircraft service pit according claim 5, wherein the controller is further adapted for compensation of the output cable voltage drop.

10. An aircraft service pit according to claim 5, wherein the controller is further adapted for compensation of output cable impedance.

11. An aircraft service pit according to claim 10, wherein the output cable impedance is determined and stored in the controller before connection to an airplane for compensation of the impedance during operation of the ground power unit.
